(19) United States
(12) Patent Application Publication
(10) Pub. No.: US 2014/0344827 A1
(43) Pub. Date: Nov. 20, 2014

(54) SYSTEM, METHOD, AND COMPUTER PROGRAM PRODUCT FOR SCHEDULING A TASK TO BE PERFORMED BY AT LEAST ONE PROCESSOR CORE

(71) Applicant: NVIDIA Corporation, Santa Clara, CA (US)

(72) Inventors: Rajith Kumar Mavila, Bangalore (IN); Ravi Prasad Bulusu, Hyderabad (IN)

(73) Assignee: NVIDIA Corporation, Santa Clara, CA (US)

(21) Appl. No.: 13/896,261

(22) Filed: May 16, 2013

(51) Int. Cl. G06F 9/50

(52) U.S. Cl. CPC G06F 9/5094
USPC 718/104

(57) ABSTRACT

A system, method, and computer program product are provided for scheduling a task to be performed by at least one processor core. In operation, a task to be performed by at least one of a plurality of processor cores is identified. Additionally, a temperature of each of the plurality of processor cores is determined. Further, a first processor core of the plurality of processor cores is identified based on at least the determined temperature of each of the plurality of processor cores and, in one embodiment, spatial information associated with each of the plurality of processor cores. Still yet, at least a portion of the task is scheduled to be performed by the first processor core.

### FIELD OF THE INVENTION

The present invention relates to processors, and more particularly to task management associated with processors.

### BACKGROUND

The thermal limits imposed by processor package and platform design determine the sustained performance that can be supported by processors. In the mobile processor arena, the cooling solutions available are limited due to the limited real estate of the processor platform and the lack of active cooling devices. However, performance expectations of processor platforms are increasing. It is beneficial to accurately monitor chip temperature and take actions to check the temperature rise associated with processors. One common technique used to throttle back power consumption of a processor is throttling down clock frequencies used by various engines in the system on a chip (SoC) associated with the processors.

In some current thermal throttling algorithms, the chip temperature is monitored and CPU and/or CPU frequencies may be throttled based on pre-defined thresholds and throttle vectors. The maximum temperature among the processors is the value considered for comparison, primarily because resources common for all processors are throttled (e.g. PLL, etc.). Essentially, the un-throttled performance is allowed to create enough temperature increase to start throttling back performance. There is thus a need for addressing these and/or other issues associated with the prior art.

### SUMMARY

A system, method, and computer program product are provided for scheduling a task to be performed by at least one processor core. In operation, a task to be performed by at least one of a plurality of processor cores is identified. Additionally, a temperature of each of the plurality of processor cores is determined. Further, a first processor core of the plurality of processor cores is identified based on at least the determined temperature of each of the plurality of processor cores. Still yet, at least a portion of the task is scheduled to be performed by the first processor core.

### BRIEF DESCRIPTION OF THE DRAWINGS

FIG. 1 shows a method for scheduling a task to be performed by at least one processor core, in accordance with one embodiment.

FIG. 2 shows a system flow for scheduling a task to be perforated by at least one processor core, in accordance with another embodiment.

FIG. 3 shows a method for scheduling a task to be performed by at least one processor core, in accordance with another embodiment.

FIG. 4 shows a method for scheduling a task to be perforated by at least one processor core, in accordance with another embodiment.

FIG. 5 illustrates an exemplary system in which the various architecture and/or functionality of the various previous embodiments may be implemented.

### DETAILED DESCRIPTION

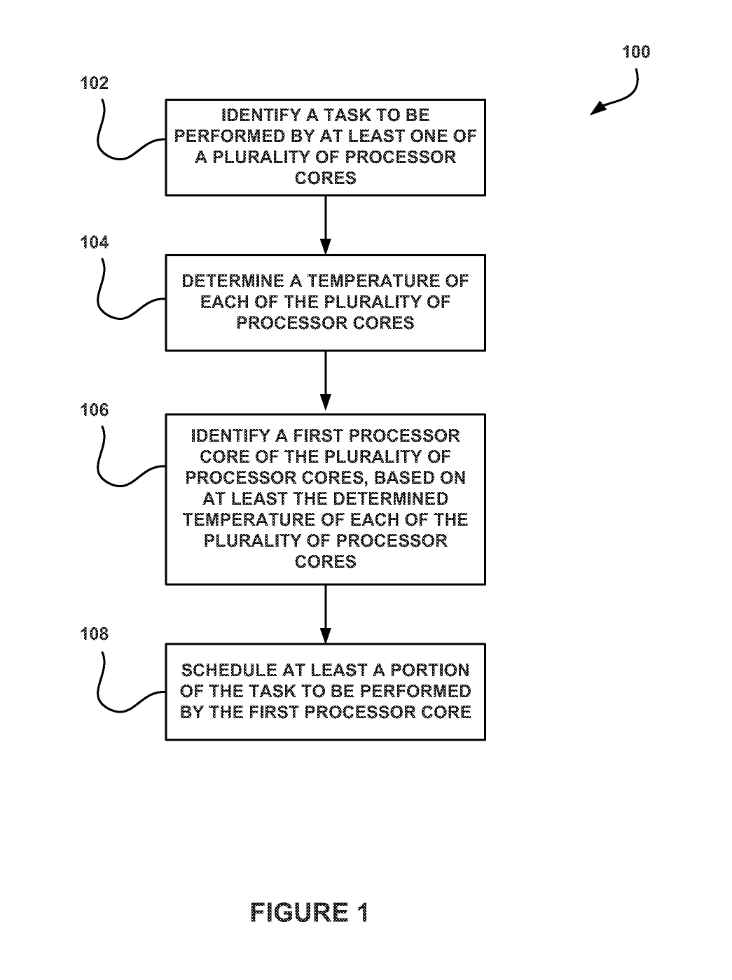

FIG. 1 shows a method 100 for scheduling a task to be performed by at least one processor core, in accordance with one embodiment.

As shown, a task to be performed by at least one of a plurality of processor cores is identified. See operation 102. Additionally, a temperature of each of the plurality of processor cores is determined. See operation 104.

Further, a first processor core of the plurality of processor cores is identified based on at least the determined temperature of each of the plurality of processor cores. See operation 106. Still yet, at least a portion of the task is scheduled to be performed by the first processor core. See operation 108.

The task may include any task capable of being at least partially performed by a processor core. For example, in various embodiments, the task may include a task associated with an application, an operating system, a calculation, software, a program, and/or any other type of task.

Further, the temperature of the processor cores may be determined in a variety of ways. For example, in one embodiment, each of the processor cores may have the ability to measure a temperature associated therewith. As another example, external devices may be utilized to measure the temperature of the processor cores. In another embodiment, software may be utilized to determine the temperature.

In one embodiment, the temperature of each of the processor cores may be sent to and/or read by one or more task schedulers. In the context of the present description, a task scheduler refers to any device and/or code that is capable of scheduling tasks to one or more processor cores.

The first processor core to which at least a portion of the task is scheduled may be identified in variety of ways. For example, in one embodiment, identifying the first processor core of the plurality of processor cores may include identifying the coolest processor core of the plurality of processor cores, based on the determined temperature of each of the plurality of processor cores.

Furthermore, in one embodiment, the method 100 may farther include determining spatial information associated with each of the plurality of processor cores. In this case, in one embodiment, the first processor core of the plurality of processor cores may be identified based on at least the determined temperature of each of the plurality of processor cores and the determined spatial information associated with each of the plurality of processor cores. In one embodiment, determining spatial information associated with each of the plurality of processor cores may include performing a look-up operation. In another embodiment, the spatial information may be included in firmware and/or software associated with the processor cores and/or one or more task schedulers.

The spatial information may include any information associated with the location and/or position of one or more of the processor cores. For example, in one embodiment, the spatial information associated with each of the plurality of processor cores may include a distance of the first processor core from each of the plurality of processor cores. In one embodiment, the distance may include a distance from a midpoint of the first processor core from a midpoint of each of other the plurality of processor cores.

In another embodiment, the distance may include a distance from a hot-point of the first processor core from a midpoint of each of the plurality of processor cores. In the context of the present description, a hot-point of a processor core refers a location of the processor core that is associated with a maximum temperature (or maximum temperature gradient, etc.). Additionally, in one embodiment, the spatial information associated with each of the plurality of processor cores may include coordinates of the processor cores (e.g. x, y coordinates, etc.).

Further, in one embodiment, a thermal proximity score may be determined for each of the plurality of processor cores. In one embodiment, the thermal proximity score may be determined utilizing the determined temperature of each of the plurality of processor cores and the determined spatial information associated with each of the plurality of processor cores. In this case, in one embodiment, the first processor core may be identified based on the thermal proximity score for each of the plurality of processor cores.

In one embodiment, the thermal proximity score, or a derivative thereof, may be utilized to determine a work load for each of the plurality of processor cores. In another embodiment, the thermal proximity score, or a derivative thereof, may be utilized in a processor load equation associated with each of the plurality of processor cores. Still yet, in one embodiment, the first processor core may be identified based on a percentage of a magnitude of the thermal proximity score of the first processor core and a total of each magnitude of the thermal proximity scores for each of the plurality of processor cores.

In another embodiment, thermal gradients for each of the plurality of processor cores may be determined. In this case, in one embodiment, the first processor core may be identified based on the determined thermal gradients for each of the plurality of processor cores.

Furthermore, in one embodiment, scheduling at least a portion of the task to be performed by the first processor core may include scheduling the entire task to be performed by the first processor core. In another embodiment, scheduling at least a portion of the task to be performed by the first processor core may include scheduling a first portion of the task to be performed by the first processor core. In this case, in one embodiment, a second portion of the task may be scheduled to be performed by a second processor core of the plurality of processor cores.

In one embodiment, the second processor core may be identified based on at least the determined temperature of each of the plurality of processor cores. Additionally, in one embodiment, the second processor core may be identified based on at least the determined temperature of each of the plurality of processor cores and the determined spatial information associated with each of the plurality of processor cores. In this way, spatial information of the processor cores (e.g. distances with respect to each other, etc.) and processor core specific temperatures may be utilized to determine an ideal processor core for receiving a task.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

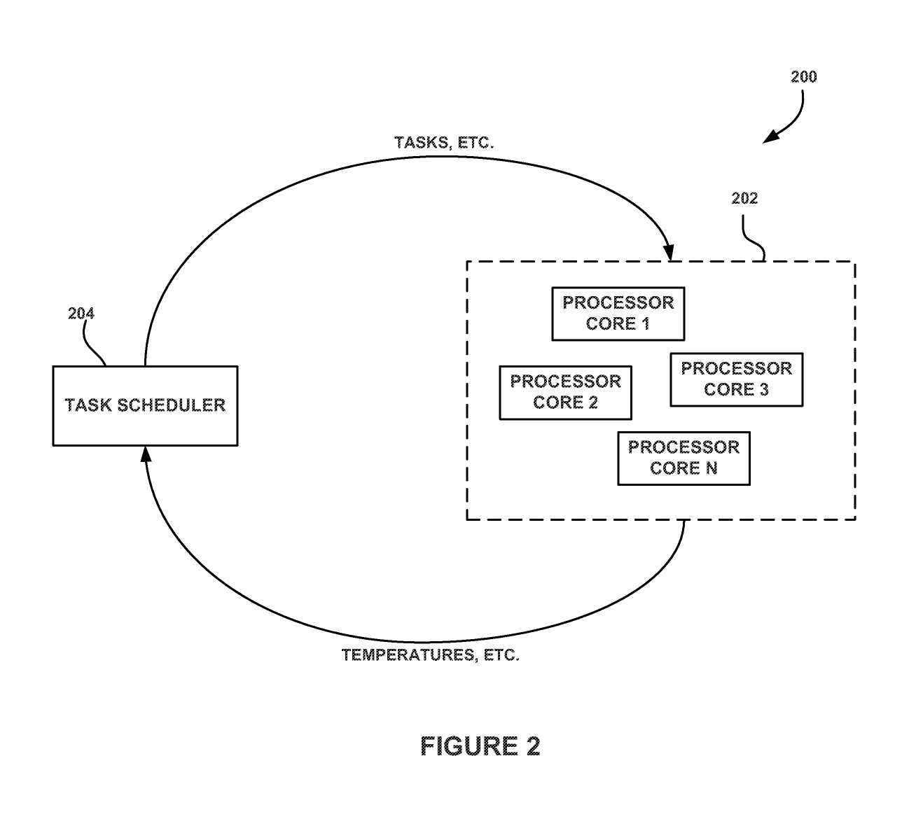

FIG. 2 shows a system flow 200 for scheduling a task to be performed by at least one processor core, in accordance with another embodiment. As an option, the system flow 200 may be implemented in the context of the functionality of the previous Figure and/or any subsequent Figure(s). Of course, however, the system flow 200 may be implemented in the context of any desired environment. It should also be noted that the aforementioned definitions may apply during the present description.

As shown, a plurality of processor cores 202 may be in communication with one or more task schedulers 204. In operation, the task scheduler 204 may communicate tasks to one or more of the processor cores 202 based on a temperature of the processor cores 202. Further, in one embodiment, the task scheduler 204 may communicate tasks to one or more of the processor cores 202 based on the temperature of the processor cores 202 and a proximity of the designated processor core to other warm processor cores.

For example, in one embodiment, temporal and spatial temperature information of processors (e.g. CPUs, GPUs, etc.) may be utilized by the task scheduler 204 to spread the thermal load associated with processing among active processor cores 202. In this way, in one embodiment, a thermally balanced system may be achieved with a low maximum temperature reached for a given work load by sustaining thermal gradients between the processor cores 202.

As an example, thermal conductivity of Silicon reduces with temperature (e.g. roughly by 20% between 27 degrees C. and 77 degrees C., etc.). Thus, in some cases, greater sustained temperature gradients may be possible at higher temperatures due to this effect. Accordingly, in one embodiment, enhanced load managing capabilities may be implemented at higher processor temperatures such that techniques extracting the thermal gradient information at these temperature ranges may be beneficial for containing the maximum temperature reached by a chip.

In operation, in one embodiment, software may be utilized to continuously monitor a temperature for each of the processor cores 202. This temperature information may be made available to the task scheduler 204. In one embodiment, processor core specific temperature information may be exposed to software through registers in thermal sensing logic.

Further, in one embodiment, (e.g. when temperature information for all processor cores is not available in hardware at the same time, etc.) software loops may be utilized to gather temperature information for the processor cores 202. For example, Table 1 shows exemplary pseudo code for gathering temperature information for each of the processor cores 202, in accordance with one embodiment.

TABLE 1

for_each (core = 0, core <4, core++)

{

SENSOR_STOP[0] = 1
SENSOR_STOP[1] = 1
SENSOR_STOP[2] = 1
SENSOR_STOP[3] = 1
wait_us(TBD);
SENSOR_STOP[core] = 0 ;
Read_temp[core];
wait_us(loop_delay);

}

In this case, in one embodiment, the “loop delay” may be configured to ensure that the temperature collection is fast enough for a supported task scheduling frequency. Of course, in one embodiment, software and/or the task scheduler 204 may receive information associated with individual core temperatures at a fine enough granularity such that task scheduling decisions may be influenced.

In one embodiment, the core specific temperature values may be made available to the task scheduler 204 such that efficient thermal management of the processor cores 202 may be implemented. In one embodiment, a scheduling algorithm associated with the task scheduler 204 may examine the individual core temperatures of the processor cores 202 and a new task may be scheduled to the coolest processor core.

However, in some cases, the processor core at the lowest temperature at a given point in time may also be the processor core closest to an already hot processor core. Even at a relatively lower level of activity, in some cases, the coolest processor core may be on the way to an increased temperature (e.g. due to the proximity to a hot core, etc.) in the near future. Accordingly, in some cases, there may be a better alternative core to receive a task from a thermal perspective. For example, although the alternative processor core may be at a slightly higher temperature, the alternative processor core may be at a farther distance from the hottest processor core.

Accordingly, in one embodiment, spatial information of the processor cores 202 (e.g. distances with respect to each other, etc.) may be utilized along with processor core specific temperatures to determine the ideal processor core to receive a task. In one embodiment, the distance values associated with the processor cores 202 may be fine-tuned by hot spot characterization (e.g. because it may be the individual hot spot separation that is effecting the overall thermal landscape, etc.). In another embodiment, distances between mid-points of each processor core may be utilized.

Further, in one embodiment, the spatial temperature information may be utilized to determine a thermal proximity score for each processor core. For example, in one embodiment, a thermal proximity score (S) may be determined for each processor core that is being considered for receiving a task. In one embodiment (e.g. for a four core system, etc.), the thermal proximity score for core_j may be determined as:

$$S\_j = {\sum }_{i = 0}^{i = 3} ( Ti - Tj ) / Dij ,$$

where i≠j, and Dij is the distance between core_i and core_j.

This metric captures the inverse relation of the distance to heating due to conduction and the temperature gradient. In this case, S_j of a processor core is a value that indicates that core's tendency to increase its temperature due to its immediate environment, assuming a current power consumption scenario remains constant. Accordingly, in one embodiment, the scheduling algorithm may pick a processor core with the lowest positive S_j value to receive the next task.

In another embodiment, an existing processor load equation (e.g. a CPU load equation, etc.) may be enhanced by factoring in the proximity score as: Temp_aware_cpuₙ_{_{—}}load=w₁*(cpuₙ_{_{—}}load)+w₂*Sn, where w₁ and w₂ are tunable parameters and Sn is the percentage of the magnitude of thermal proximity score of CPUn to the total of CPU proximity score's magnitudes.

It should be noted that although four processor cores were referenced in the context of FIG. 2, in various embodiments, any number of processor cores may be utilized. It should also be noted that this concept may be extended to CPU and non-CPU IPs as well. For example spatial temperature considerations can be potentially used when tasks are distributed among many available GPU (Graphics processor units) cores, or between a CPU and GPU.

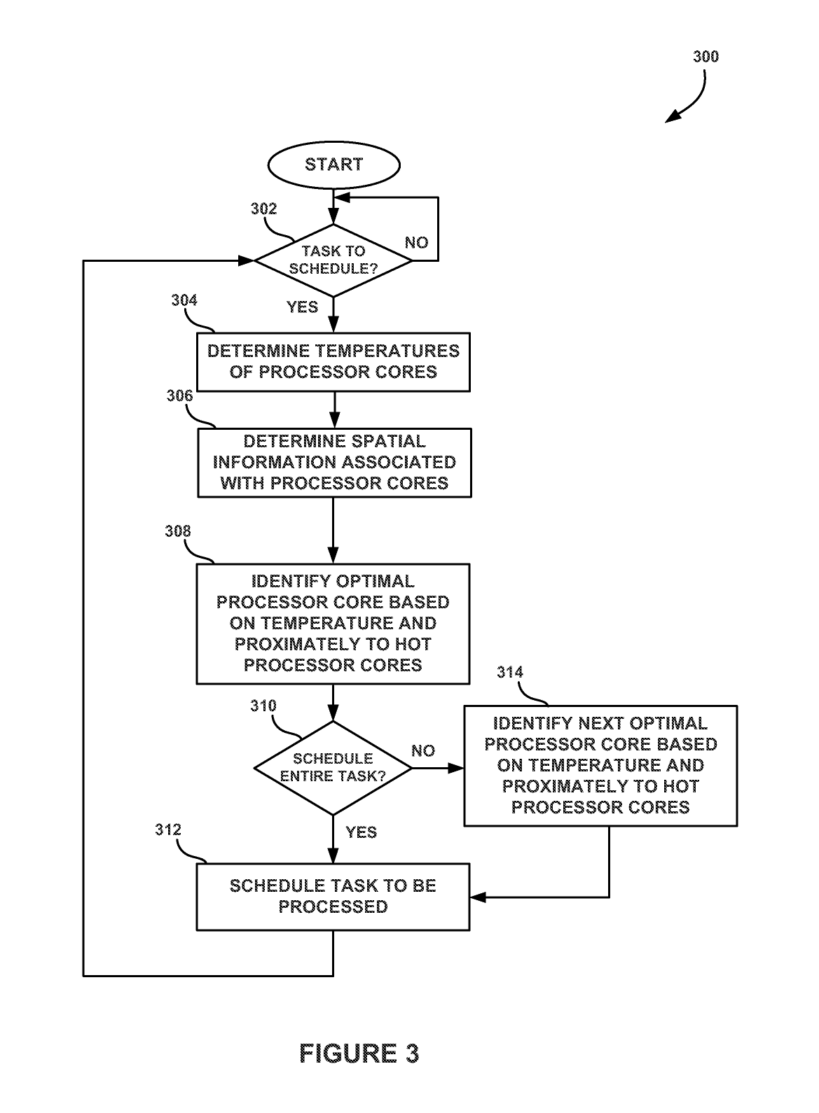

FIG. 3 shows a method 300 for scheduling a task to be performed by at least one processor core, in accordance with another embodiment. As an option, the method 300 may be implemented in the context of the functionality and architecture of the previous Figures and/or any subsequent Figure(s). Of course, however, the method 300 may be carried out in any desired environment. It should also be noted that the aforementioned definitions may apply during the present description.

As shown, it is determined whether there is a task to be scheduled. See decision 302. In one embodiment, a task scheduler may determine whether there is a task to be scheduled.

If it is determined that a task is to be scheduled, temperatures of processor cores associated with a system are determined. See operation 304. In one embodiment, determining the temperatures may include sending a request for the temperatures. In another embodiment, determining the temperatures may include receiving the temperatures (e.g. periodically, etc.).

Further, in one embodiment, software associated with a task scheduler may determine (or read, receive, etc.) the temperatures. In one embodiment, the temperatures for all processor cores associated with a system may be determined at or around the same time. In another embodiment, the temperatures for processor cores associated with a system may be determined at different times.

In addition to determining the temperatures, spatial information associated with the processor cores is determined. See operation 306. In one embodiment, the spatial information may be static information.

In one embodiment, the spatial information may be determined by the task scheduler. Additionally, in one embodiment, at least a portion of the spatial information may be determined at design time (e.g. design time of a chip including the processor cores, etc.). In another embodiment, the spatial information may be determined during a test period (e.g. during a test time of a chip including the processor cores, etc.).

Further, in various embodiments, the spatial information may include a distance of a first processor core from a second processor core (e.g. and/or a third processor core, a fourth processor core, etc.), coordinates of the processor cores (e.g. such that distances from each processor core may be determined, etc.), and/or any other spatial information. Additionally, in various embodiments, the distances between the processor cores may include distances between a center point of the processor cores, distances between processor cores, and/or distances between determined hot-points of the processor cores.

Once the temperatures and the spatial information are determined, an optimal processor core for receiving at least a portion of the task is determined, based on the temperature of that processor core and its proximity to other hot processor cores. See operation 308. For example, the coolest processor core may not always necessarily be the optimal core to receive a task because of its close proximity to a hot processor core. Accordingly, in one embodiment, both the temperature of a processor core and its proximity to other hot processor cores may be utilized to determine whether the processor core should receive a task.

Further, in one embodiment, it may be determined whether the optimal core is to receive the entire task for processing or whether the task is to be split among multiple processor cores. See decision 310. For example, in one embodiment, it may be determined to split the task between two or more processor cores to spread the thermal load of the system. In another embodiment, it may be determined that the task is to be passed among multiple processor cores to be processed in order to distribute a thermal load (e.g. by core hopping, etc.).

If it is determined that the optimal processor core is to receive the entire task for processing, the task is scheduled for the optimal processor core. See operation 312. Subsequently, the optimal processor core will process the task.

If it is determined that the task is to be split among multiple processor cores, a next optimal processor core for receiving a portion of the task is determined, based on the temperature of that processor core and its proximity to other hot processor cores. See operation 314.

Further, a portion of the task is scheduled for the optimal processor core and another portion of the task is scheduled for the next optimal processor core. In one embodiment, the processor cores may process the task coincidently (e.g. in parallel, etc.). In another embodiment, the optimal processor core may process a portion of the task and then the next optimal processor core may process another portion of the task when the optimal processor core has at least partially completed the processing.

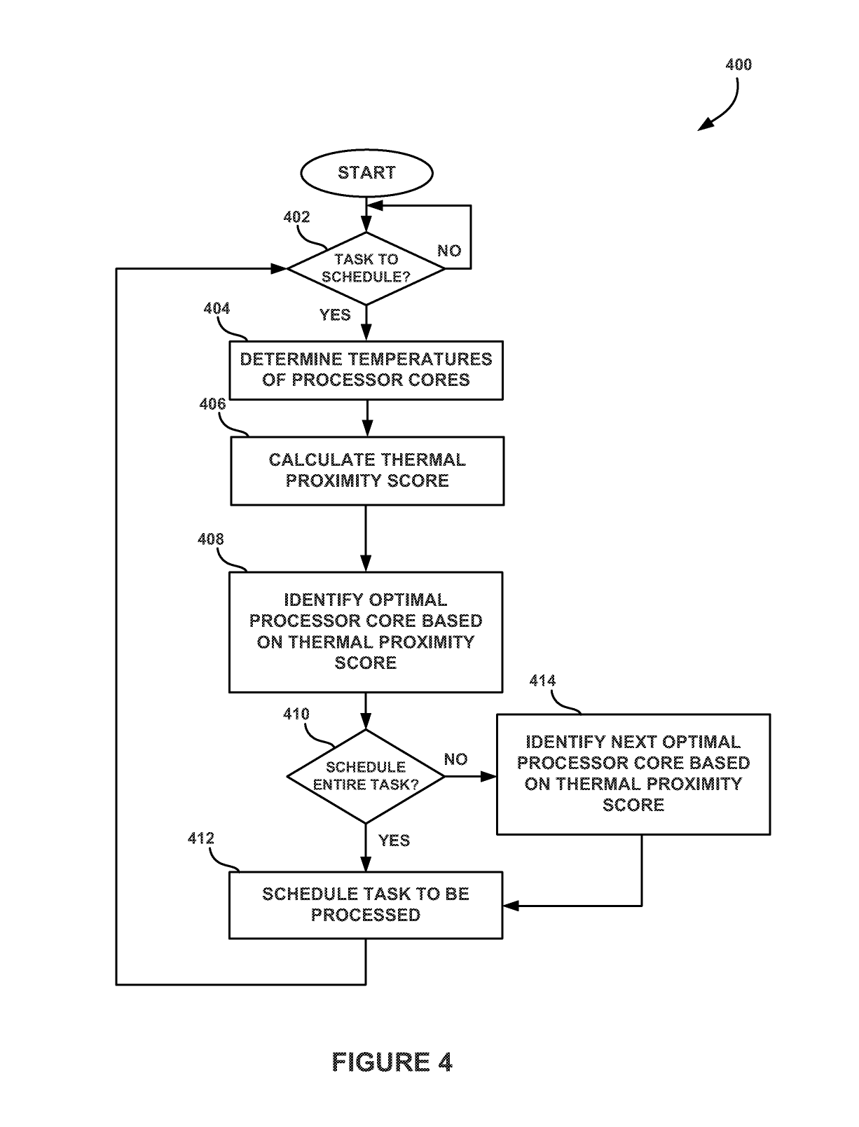

FIG. 4 shows a method 400 for scheduling a task to be performed by at least one processor core, in accordance with another embodiment. As an option, the method 400 may be implemented in the context of the functionality and architecture of the previous Figures and/or any subsequent Figure(s). Of course, however, the method 400 may be carried out in any desired environment. It should also be noted that the aforementioned definitions may apply during the present description.

As shown, it is determined whether there is a task to be scheduled. See decision 402. In one embodiment, a task scheduler may determine whether there is a task to be scheduled.

If it is determined that a task is to be scheduled, temperatures of processor cores associated with a system are determined. See operation 404. In one embodiment, determining the temperatures may include sending a request for the temperatures. In another embodiment, determining the temperatures may include receiving the temperatures (e.g. periodically, etc.).

Further, in one embodiment, software associated with a task scheduler may determine (or read, receive, etc.) the temperatures. In one embodiment, the temperatures for all processor cores associated with a system may be determined at or around the same time. In another embodiment, the temperatures for processor cores associated with a system may be determined at different times.

Utilizing the determined temperatures and known spatial information, a thermal proximity score is calculated for each processor core. See operation 406. In one embodiment, the thermal proximity score may be calculated by:

$$S\_j = {\sum }_{i = 0}^{i = n} ( Ti - Tj ) Dij ,$$

where n equals the number of processor cores in a system, i≠j, and Dij is the distance between core i and core j.

Further, an optimal processor core to handle the task is identified based on the thermal proximity score (S_j). See operation 408. In one embodiment, the optimal processor core may include the processor core with the lowest positive S_j value.

In one embodiment, it may be determined whether the optimal processor core is to receive the entire task for processing or whether the task is to be split among multiple processor cores. See decision 410. For example, in one embodiment, it may be determined to split the task between two or more processor cores to spread the thermal load of the system. In another embodiment, it may be determined that the task is to be passed among multiple processor cores to be processed in order to distribute a thermal load (e.g. by core hopping, etc.).

If it is determined that the optimal processor core is to receive the entire task for processing, the task is scheduled for the optimal processor core. See operation 412. Subsequently, the optimal processor core will process the task.

If it is determined that the task is to be split among multiple processor cores, a next optimal processor core for receiving a portion of the task is determined, based on the thermal proximity score. See decision 414. Further, a portion of the task is scheduled for the optimal processor core and another portion of the task is scheduled for the next optimal processor core. In one embodiment, the processor cores may process the task coincidently. In another embodiment, the optimal processor core may process a portion of the task and then the next optimal processor core may process another portion of the task when the optimal processor core has at least partially completed the processing.

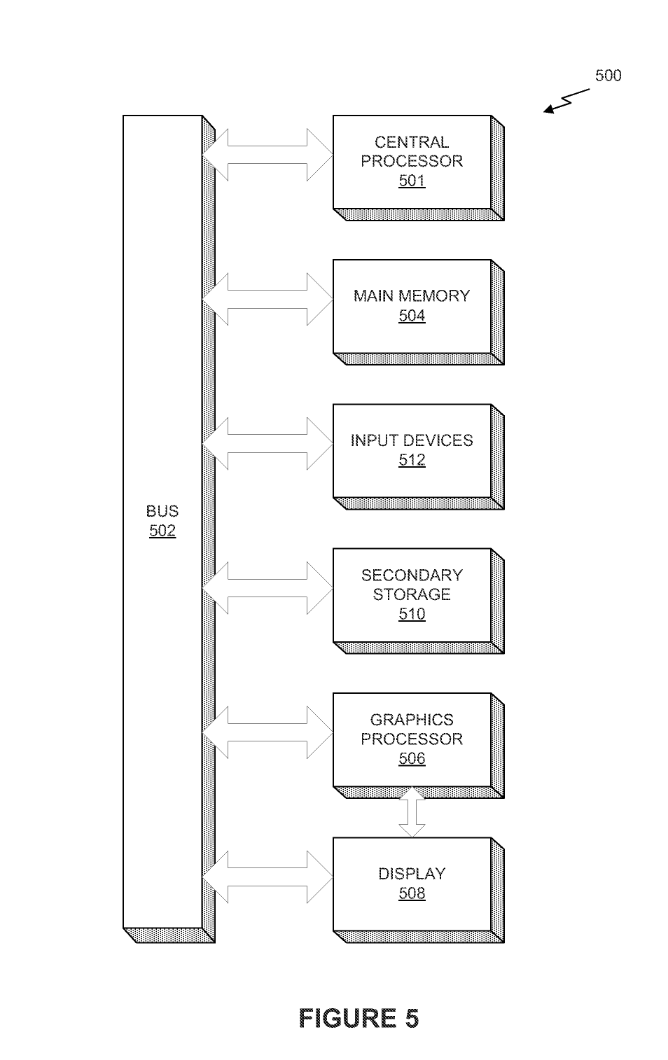

FIG. 5 illustrates an exemplary system 500 in which the various architecture and/or functionality of the various previous embodiments may be implemented. As shown, a system 500 is provided including at least one central processor 501 that is connected to a communication bus 502. The communication bus 502 may be implemented using any suitable protocol, such as PCI (Peripheral Component Interconnect), PCI-Express, AGP (Accelerated Graphics Port), HyperTransport, or any other bus or point-to-point communication protocol(s). The system 500 also includes a main memory 504. Control logic (software) and data are stored in the main memory 504 which may take the form of random access memory (RAM).

The system 500 also includes input devices 512, a graphics processor 506, and a display 508, i.e. a conventional CRT (cathode ray tube), LCD (liquid crystal display), LED (light emitting diode), plasma display or the like. User input may be received from the input devices 512, e.g., keyboard, mouse, touchpad, microphone, and the like. In one embodiment, the graphics processor 506 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 500 may also include a secondary storage 510. The secondary storage 510 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. Computer programs, or computer control logic algorithms, may be stored in the main memory 504 and/or the secondary storage 510. Such computer programs, when executed, enable the system 500 to perform various functions. The main memory 504, the storage 510, and/or any other storage are possible examples of computer-readable media.

In one embodiment, the architecture and/or functionality of the various previous figures may be implemented in the context of the central processor 501, the graphics processor 506, an integrated circuit (not shown) that is capable of at least a portion of the capabilities of both the central processor 501 and the graphics processor 506, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 500 may take the form of a desktop computer, laptop computer, server, workstation, game consoles, embedded system, and/or any other type of logic. Still yet, the system 500 may take the form of various other devices including, but not limited to a personal digital assistant (PDA) device, a mobile phone device, a television, etc.

Further, while not shown, the system 500 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A non-transitory computer-readable storage medium storing instructions that, when executed by a processor, cause the processor to perform steps comprising:
identifying a task to be performed by at least one of a plurality of processor cores;
determining a temperature of each of the plurality of processor cores;
identifying a first processor core of the plurality of processor cores, based on at least the determined temperature of each of the plurality of processor cores; and
scheduling at least a portion of the task to be performed by the first processor core.

2. The computer-readable storage medium of claim 1, wherein identifying the first processor core of the plurality of processor cores includes identifying the coolest processor core of the plurality of processor cores, based on the determined temperature of each of the plurality of processor cores.

3. The computer-readable storage medium of claim 1, further comprising determining spatial information associated with each of the plurality of processor cores.

4. The computer-readable storage medium of claim 3, wherein the first processor core of the plurality of processor cores is identified based on at least the determined temperature of each of the plurality of processor cores and the determined spatial information associated with each of the plurality of processor cores.

5. The computer-readable storage medium of claim 4, wherein the spatial information associated with each of the plurality of processor cores includes a distance of the first processor core from each of the plurality of processor cores.

6. The computer-readable storage medium of claim 5, wherein the distance includes a distance from a midpoint of the first processor core from a midpoint of each of the plurality of processor cores.

7. The computer-readable storage medium of claim 5, wherein the distance includes a distance from a hot-point of the first processor core from a midpoint of each of the plurality of processor cores.

8. The computer-readable storage medium of claim 4, further comprising determining a thermal proximity score for each of the plurality of processor cores.

9. The computer-readable storage medium of claim 8, wherein the thermal proximity score is determined utilizing the determined temperature of each of the plurality of processor cores and the determined spatial information associated with each of the plurality of processor cores.

10. The computer-readable storage medium of claim 9, wherein the first processor core is identified based on the thermal proximity score for each of the plurality of processor cores.

11. The computer-readable storage medium of claim 9, wherein the thermal proximity score, or a derivative thereof, is utilized to determine a work load for each of the plurality of processor cores.

12. The computer-readable storage medium of claim 9, wherein the thermal proximity score, or a derivative thereof, is utilized in a processor load equation associated with each of the plurality of processor cores.

13. The computer-readable storage medium of claim 9, wherein the first processor core is identified based on a percentage of a magnitude of the thermal proximity score of the first processor core and a total of each magnitude of the thermal proximity scores for each of the plurality of processor cores.

14. The computer-readable storage medium of claim 1, further comprising determining thermal gradients for each of the plurality of processor cores.

15. The computer-readable storage medium of claim 14, wherein the first processor core is identified based on the determined thermal gradients for each of the plurality of processor cores.

16. The computer-readable storage medium of claim 1, wherein scheduling at least a portion of the task to be performed by the first processor core includes scheduling the entire task to be performed by the first processor core.

17. The computer-readable storage medium of claim 1, wherein scheduling at least a portion of the task to be performed by the first processor core includes scheduling a first portion of the task to be performed by the first processor core.

18. The computer-readable storage medium of claim 17, further comprising scheduling a second portion of the task to be performed by a second processor core of the plurality of processor cores, the second processor core being identified based on at least the determined temperature of each of the plurality of processor cores.

19. A method, comprising:
identifying a task to be performed by at least one of a plurality of processor cores;
determining a temperature of each of the plurality of processor cores;
identifying a first processor core of the plurality of processor cores, based on at least the determined temperature of each of the plurality of processor cores; and
scheduling at least a portion of the task to be performed by the first processor core.

20. A system, comprising:
at least one processor operable to identify a task to be performed by at least one of a plurality of processor cores, determine a temperature of each of the plurality of processor cores, identify a first processor core of the plurality of processor cores based on at least the determined temperature of each of the plurality of processor cores, and schedule at least a portion of the task to be performed by the first processor core.
